(19) United States
(12) Patent Application Publication
(10) Pub. No.: US 2014/0156303 A1
(43) Pub. Date: Jun. 5, 2014

(54) PROCESSING OF CLINICAL DATA FOR VALIDATION OF SELECTED CLINICAL PROCEDURES

(71) Applicants: Gary Pacheco, Kitchener (CA); John Delong, Kitchener (CA); Paul Van Arragon, Kitchener (CA); Jeremy Hossfeld, Kitchener (CA); Tiffany Quinlan, Kitchener (CA)

(72) Inventors: Gary Pacheco, Kitchener (CA); John Delong, Kitchener (CA); Paul Van Arragon, Kitchener (CA); Jeremy Hossfeld, Kitchener (CA); Tiffany Quinlan, Kitchener (CA)

(21) Appl. No.: 13/705,011

(22) Filed: Dec. 4, 2012

(51) Int. Cl. G06F 19/00; G06Q 50/24

(52) U.S. Cl. CPC G06F 19/3418; G06Q 50/24
USPC 705/3

(57) ABSTRACT

A processing system determines a validation status of an examination request for a patient. The examination request includes examination data that defines a clinical condition of the patient. A receipt module receives the examination request via a communication network; a storage module adapted for storing a plurality of predefined clinical definitions, predefined clinical definitions associated with at least one examination type. A matching module conducts a first stage analysis of the content, compares the content with the predefined clinical definitions in order to determine one or more matching definitions. A validation module compares the matching definitions against the match threshold of at least one examination type to determine a validation indicator of the examination request. A response module transmits the validation status of the exam request as an exam response via the communications network.

### RELATED APPLICATIONS

This patent application claims benefit under 35 U.S.C. 120 to and is a continuation of the United States Patent Application entitled “Processing of Clinical Data for Validation of Selected Clinical Procedures”, having Ser. No. 12/135,727, filed on Jun. 9, 2008, which claims benefits to Provisional Application No. 61/064,825, filed on Mar. 28, 2008, which are both expressly incorporated herein by reference.

### FIELD

This invention relates to the processing of orders in a clinical environment.

### BACKGROUND

In today's clinical environment, the consultation of patients and the required examinations based on those consultations requires the collection of patient information that is clinically relevant or otherwise specific to the patient, and to the examination (otherwise referred to as procedure) appropriate with the patient information collected. One problem is that there are a multitude of possibilities for requesting a specific examination/procedure, based on medical practitioner characteristics, patient characteristics, among others. With so many possibilities, it can be difficult for the medical practitioner to order the examination/procedure that is appropriate (e.g. valid) to the patient consultation at hand.

Further, unless the patient information collected for selected statements is of high quality, reflecting well the actual clinical condition of the patient, exam/procedure validation as well as further treatment of the patient may not be efficient. For example, if the collected patient information is too vague or lacking, exam/procedure validation has no basis because the clinical condition of the patient cannot be determined appropriately. Further, if the collected patient information includes accurate information, but information that isn't of primary importance, the medical practitioner could be misled into pursuing an irrelevant path of patient inquiry and/or treatment.

Accordingly, in today's clinical world, ordering the “right test” first and allowing for the flow of accurate clinical and fiscal information are keys to improving quality and managing the rise in radiology costs. The “right test” is one that is clinically appropriate (i.e. consistent with the latest clinical practice guidelines) and contains enough information so that the test can be executed accurately and safely for the patient. One problem with today's exam/procedure ordering systems is that they may not provide reliable and precise order validation. Further, another problem with today's systems is that they require inefficient usage of the primary medical practitioner's attention/time in making sure that the correct patient information is collected and that subsequently the correct exam/procedure is requested.

A further concern for static content of order/procedure validation is the quality of the statement information in examination orders. For example, needed is an interactive solution for improving the information content on the orders. Desired is a form generation system that can be used to improve the likelihood that the patient information on the examination order is more complete and relevant for the medical practitioner conducting the requested examination.

### SUMMARY

It is an object of the present invention to provide a statement form generation system to obviate or mitigate at least some of the above-presented disadvantages.

One problem is that there are a multitude of possibilities for requesting a specific examination/procedure, based on medical practitioner characteristics, patient characteristics, among others. With so many possibilities, it can be difficult for the medical practitioner to order the examination/procedure that is appropriate (e.g. valid) to the patient consultation at hand. Another problem with today's exam/procedure ordering systems is that they may not provide reliable and precise order validation. Further, another problem with today's systems is that they require inefficient usage of the primary medical practitioner's attention/time in making sure that the correct patient information is collected and that subsequently the correct exam/procedure is requested. Contrary to current art methods, provided is a processing system and/or method for determining a validation status of an examination request for a patient, the examination request having content including a plurality of examination data defining a clinical condition of the patient. The system and/or method can include a receipt module or similar functionality for receiving the examination request via a communication network; a storage or similar functionality adapted for storing a plurality of predefined clinical definitions, each of the plurality of predefined clinical definitions associated with at least one examination type, the at least one examination type having a match threshold including a subset definition set from the plurality of predefined clinical definitions. The system and/or method can include a matching module or similar functionality adapted for conducting a first stage analysis of the content by comparing the content with the plurality of predefined clinical definitions in order to determine one or more matching definitions. The system and/or method can include a validation module or similar functionality adapted for comparing the matching definitions against the match threshold of each of the at least one examination type for determining a validation indicator of the examination request. The system and/or method can include a response module or similar functionality adapted for transmitting the validation status of the exam request as an exam response via the communications network, the exam response including the validation indicator.

One aspect provided is a processing system for determining a validation status of an examination request for a patient, the examination request having content including a plurality of examination data defining a clinical condition of the patient, the system comprising: a receipt module for receiving the examination request via a communication network; a storage adapted for storing a plurality of predefined clinical definitions, each of the plurality of predefined clinical definitions associated with at least one examination type, the at least one examination type having a match threshold including a subset definition set from the plurality of predefined clinical definitions; a matching module adapted for conducting a first stage analysis of the content by comparing the content with the plurality of predefined clinical definitions in order to determine one or more matching definitions; a validation module adapted for comparing the matching definitions against the match threshold of each of the at least one examination type for determining a validation indicator of the examination request; and a response module adapted for transmitting the validation status of the exam request as an exam response via the communications network, the exam response including the validation indicator.

A further aspect provided is a method for determining a validation status of an examination request for a patient, the examination request having content including a plurality of examination data defining a clinical condition of the patient, the method comprising: receiving the examination request via a communication network; storing a plurality of predefined clinical definitions, each of the plurality of predefined clinical definitions associated with at least one examination type, the at least one examination type having a match threshold including a subset definition set from the plurality of predefined clinical definitions; conducting a first stage analysis of the content by comparing the content with the plurality of predefined clinical definitions in order to determine one or more matching definitions; comparing the matching definitions against the match threshold of each of the at least one examination type for determining a validation indicator of the examination request; and transmitting the validation status of the exam request as an exam response via the communications network, the exam response including the validation indicator.

A still further aspect provided is the content of the examination request includes a session ID for uniquely identifying the examination request as a unique session, wherein the receipt module is further adapted to receive a communication message containing the session ID after the validation indicator has been determined and the response module is further adapted to transmit the exam response after receipt of the communication message.

### BRIEF DESCRIPTION OF THE DRAWINGS

Exemplary embodiments of the invention will now be described in conjunction with the following drawings, by way of example only, in which:

FIG. 1 is a block diagram of components of a clinical order processing environment;

FIG. 2 is a block diagram of an example order validation system of the environment of FIG. 1;

FIG. 3 is an example computing device of the network of FIG. 2;

FIG. 4 shows example clinical definitions used in processing by the environment of FIG. 1;

FIG. 5 shows an example structure for interactions between components of the environment of FIG. 1;

FIG. 6 is an example operation of the validation system of FIG. 2;

FIGS. 7A and 7B are an example definition form for the exam request of FIG. 6;

FIG. 8A is an example exam response for validation system of FIG. 2;

FIG. 8B is a further example exam response for validation system of FIG. 2;

FIG. 8C is a further example exam response for validation system of FIG. 2;

FIG. 8D is a further example exam response for validation system of FIG. 2;

FIG. 8E is a further example exam response for validation system of FIG. 2;

FIG. 9 is a further embodiment operation of the exam request of FIG. 2; and

FIG. 10 is a further embodiment operation of the exam request of FIG. 2;

### DETAILED DESCRIPTION OF THE PREFERRED EMBODIMENT(S)

### Statement Form Environment 1

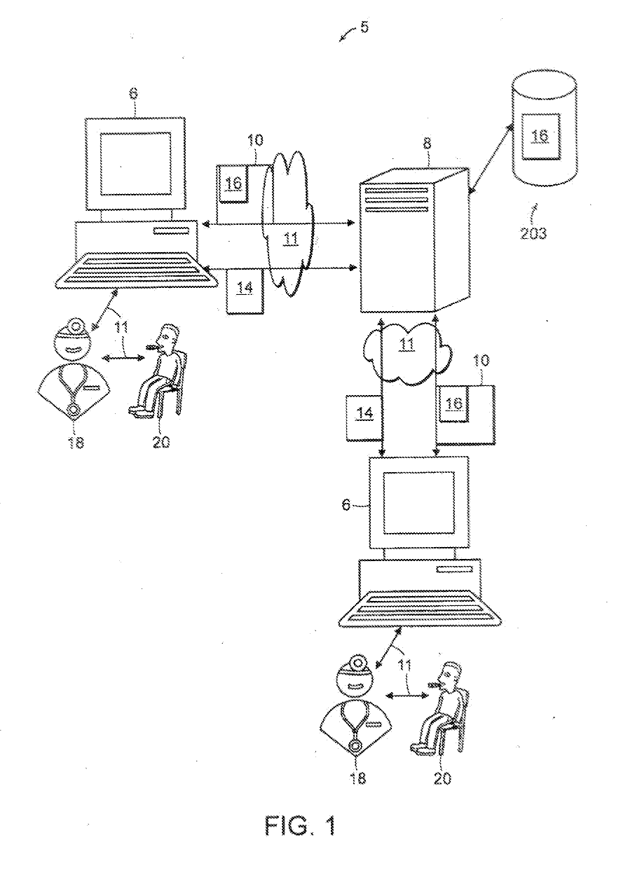

Referring to FIG. 1, a clinical order processing environment 5 includes a decision support system 8 configured for processing an examination request 10 (or series of requests 10 also referred to clinical orders/procedures), to determine an appropriate validation indicator 15 for inclusion with an examination response 14 based on the examination request 10. The examination request 10 has a set of statements 16 such as questions or other desired information including a list of clinical terms used to describe the clinical reasons for placing the examination order/request 10 (e.g. for radiology) by a medical practitioner 18 (e.g. user such as doctor, medical specialist, nurse, clinician, radiologist, intern, or other data entry personnel, etc.) in the examination/treatment of a selected patient 20. The statements 16 and information 11 supplied by the medical practitioner 18 in response to those statements 16 are hereafter referred to generically as examination data 12, which can be defined as the set of data (procedure, patient, indications, and other relevant clinical data) that describes the requisition/order 10 being validated. It is recognised that each statement 16 can have an associated UI control (e.g. checkbox, user entered text value, etc.) for facilitating medical practitioner 18 entry of patient 20 information related to the statement 16, as desired.

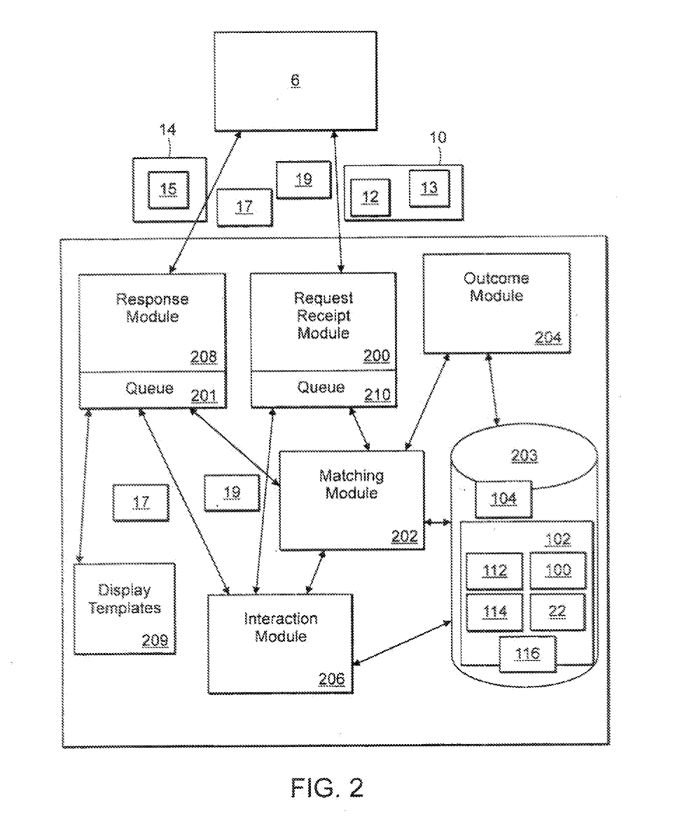

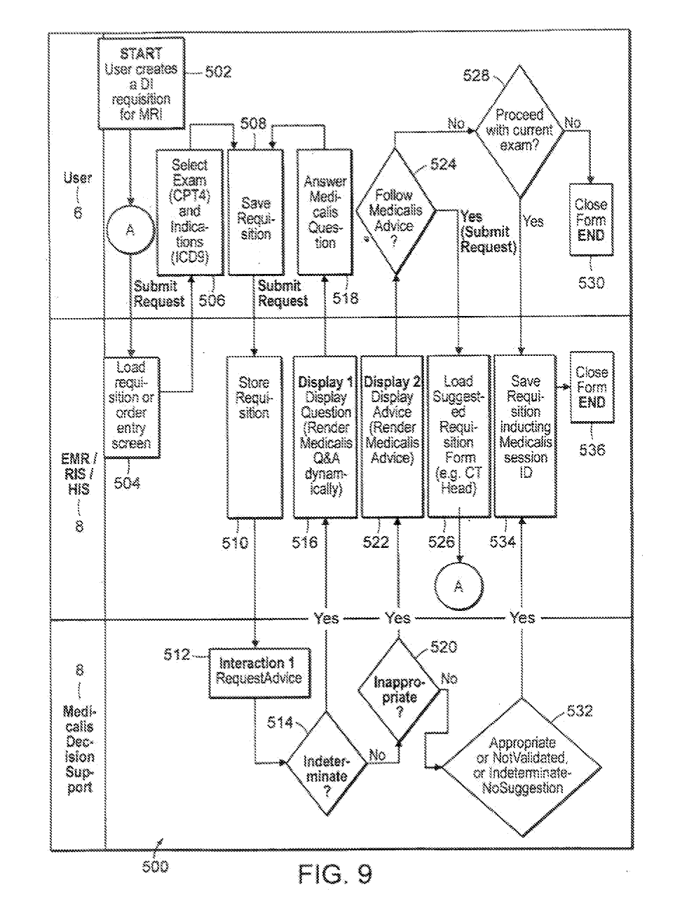

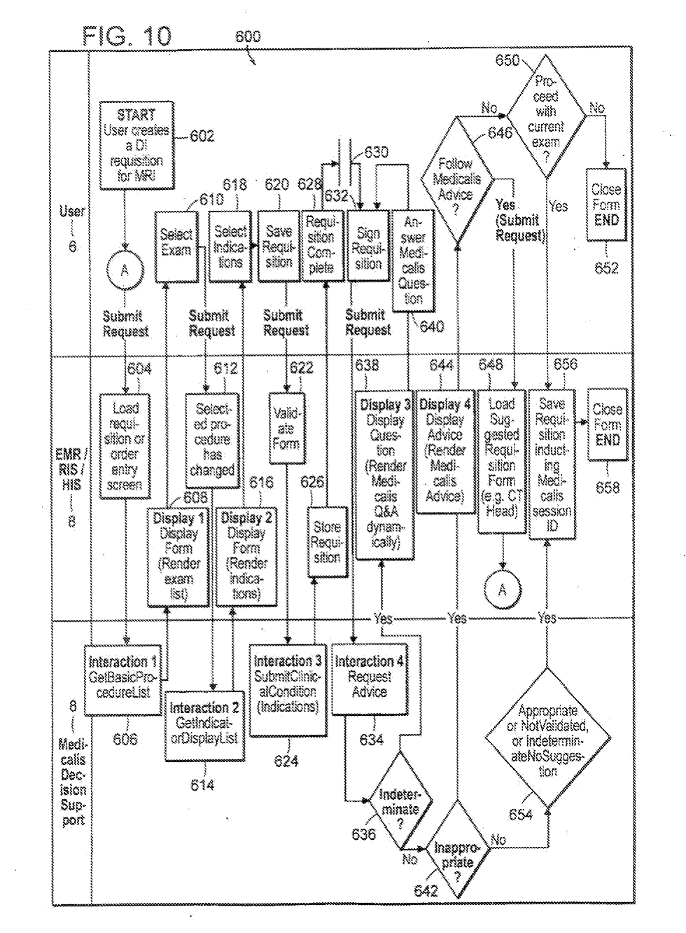

Referring to FIG. 2, the examination request 10 can also include a requested exam 13 that can be based on an examination type 22 selected from an examination catalogue (having a plurality of different ones of the initial examination types 22) and respective statements 16 associated with the requested exam 13. It is recognised in the case where a particular exam 13 is not specified in the examination request 10, the statements 16 can be of a generic nature that can be applied to a number of different examination types 22, determined by the decision support system 8, as further described below. Further, it is recognised that the medical practitioner 18 can select the patient 20 from a registered patient list. Further, it is recognised that the medical practitioner 18 can be part of a list of registered medical practitioners 18. Further, it is recognised that the set of statements 16 can be initially presented to the medical practitioner 18 on a client device 6 (as a user of the device 6) by the decision support server 8 (using predefined form display templates 209 configured for displaying the statements 16 and collecting the information 11) or other third party form generation systems 7 (see FIGS. 9 and 10), wherein at least a portion of the set of statements 16 are included in the examination request 10. An exam catalogue (not shown) can provide a menu of exam types 22 from which the medical practitioner 18 can choose in preparation for assembling the exam data 12 for the exam request 10.

Referring again to FIGS. 1 and 2, an example workflow of the system 8 is where a physician (e.g. medical practitioner 18) begins by logging on to their client device 6. Physician 18 related information can be placed in context, i.e. made available to the system 8 through association with the physician 18. After seeing the patient 20, the physician 18 may decide to place a radiology order (e.g. the exam request 14). The next step is to select the patient 20 (e.g. from a patient list), thereby putting the patient related information in context, i.e. made available to the system 8 through association with the patient 20. Next, the physician 18 will select a particular exam type 22 (e.g. such as an X-ray specifying what body part they want to X-ray). Based on the configuration of the system 8, the system receives the examination request 10 including those statements 16 used by the physician during examination of the patient 20. The examination request 10 also includes the practitioner-supplied information 11 obtained in association with each of the statements 16 in consultation with the medical condition of the patient 20. It is recognised that the obtained information associated with the statements 16 can include relevant patient information needed to facilitate subsequent treatment of the patient 20 and/or for facilitating provided feedback concerning usefulness of the chosen exam type 22 (i.e. specified exam 13), or suggestion of an alternative exam type 22. There may also be a need for further questioning about reasons for the exam 13, 22. For example, when ordering a radiology exam, the physician 18 specifies a number of items pertaining to the order/exam request 10 such as but not limited to: the exam specifics, such as a Chest X-ray (e.g. exam type 22); patient 20 identification; and reason(s) for the exam (also known as statements 16 with obtained patient specific information—e.g. exam data 12).

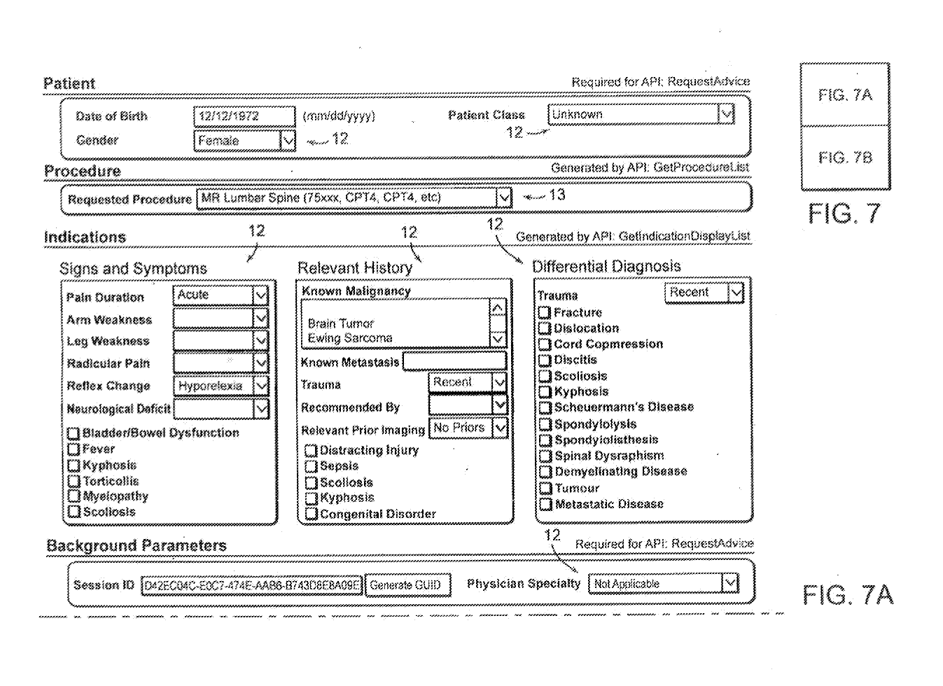

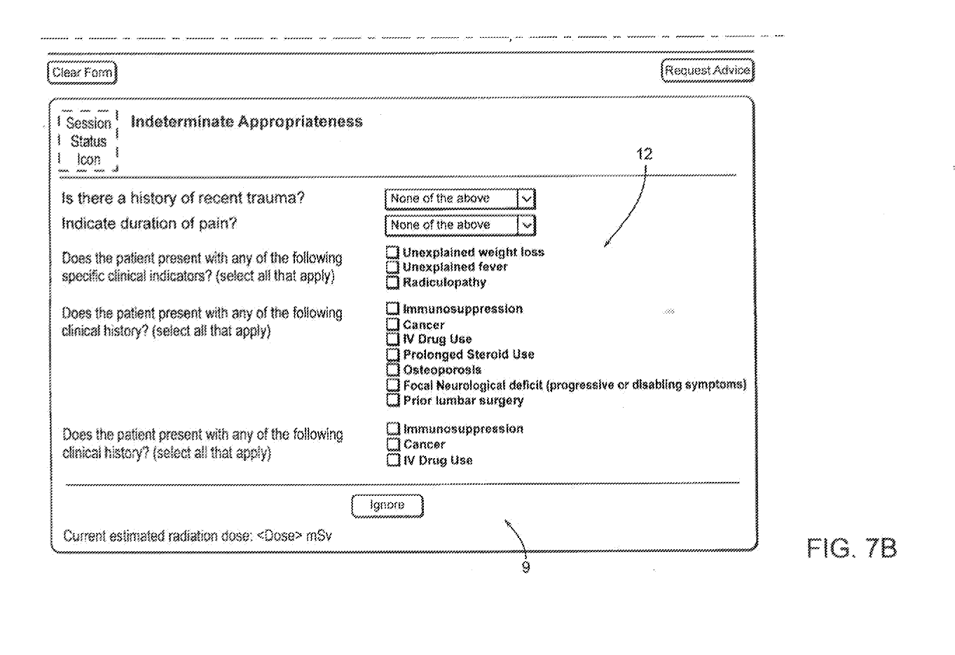

This obtained information can be entered electronically with respect to each of the statements 16 and/or can be supplied as hand-written information on a printed hard copy of the statement form. The patient information collected from the patient 20 for each of the statements 16 can be facilitated by techniques such as but not limited to: text or other values entered into a data field adjacent to the statement 16 (e.g. location of pain); selection of a predefined answer to the statement from a list of provided answers (e.g. check boxes, drop down menu selections, etc.) adjacent to the statement 16; and/or filling out a series of data fields associated with the statement 16. Accordingly, the exam request 10 includes the exam data 12 and optionally the specified/requested examination 13 related to the exam data 12. See FIG. 7 for an example set of exam data 12 and specified/requested examination 13 as collected by the medical practitioner 18 for use in submitting the exam request 10 to the system 8.

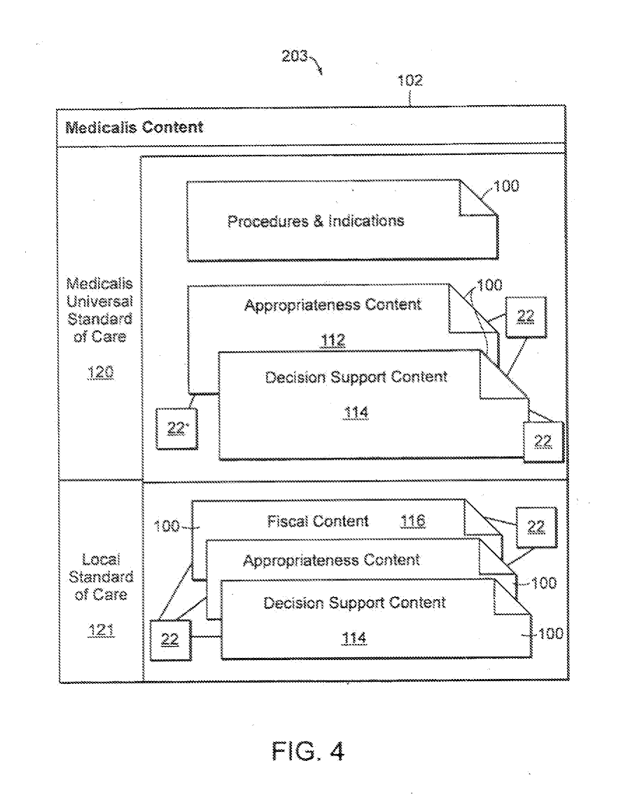

Accordingly, in view of the above, the Decision Support system 8 uses Clinical 212,214 and/or Fiscal Content 216 (further described below), which have been encoded, to determine an appropriate validation indicator 15 in response 14 to the submitted examination request 10 from client systems 6. For example, the client systems 6 that require clinical or fiscal order validation services can communicate with the Decision Support system 8 over a communications network 11 (e.g. as accessing a public API defined as a Web service). The system 8 can perform a preliminary (e.g. first stage) validation of the examination request 10 and then, if needed, ask the user (of the client 6) for additional information to validate the order appropriately, based on the exam data 12 (and/or additional information 19 in response to questions 17) collected from the client 6 by the system 8. The Decision Support system 8 can also capture outcome data, which can help show how often content 112,114,116 (see FIG. 4) is used and when advice is followed. The Decision Support system 8 can also provide tools to manage statement/definition 16 catalogs, content rules, and other aspects of the system's 8 operation. It is recognised that the various client computing devices 6 and the computing device(s) of the decision support system 8 can communicate with one another via one or more networks 11, such as but not limited to intranets and extranets (e.g. the Internet) as desired.

### Statements 16

The statements 16 for each of the exam types 22 (and the specified exam 13) can be selected from; examination related statements, patient related statements, and medical practitioner related statements, for example, all hereafter referred to generically as procedure definitions 102. These examination related definitions 102 can be such as but not limited to: modality type (e.g. CT, X-ray, MRI, etc.); procedure type and/or modifiers; body system; and/or body part/region, such that for each exam type 22, associated are the exam attributes modality and/or the body part (e.g. the exam definitions 102). For example, the exam request 10 can use adapted codes as definitions 102, such as CPT4 (Current Procedural Terminology, 4th Edition) codes.

For example, examination type 22 content (defined by the definitions 102) can contain a global list of diagnostic imaging procedures, such that each examination type/procedure 22 can be encoded with the following example attributes, such as but not limited to: ID—the procedure ID uniquely identifying this procedure; CPT4 List—the CPT4 codes that are relevant for this procedure; Name—the name of the procedure, including contrast and views; Modality—the modality used for the procedure; Dose—the estimated effective radiation dose that the patient will be exposed to for this procedure, e.g. radiation dose can be measured in millisieverts (mSv); Body Part List—the list of body parts that are relevant to this procedure; Body Region—the body region relevant to this procedure; Contrast Modifier—the specified contrast modifier for this procedure; Procedure Type—example: Screening, Diagnostic, Interventional; Laterality Applicable—determines of laterality is relevant for this procedure, wherein it is recognised that not all procedures need to be “orderable”, that is, some procedures may exist only for decision support purposes. These orders can be filtered out of the final procedure list provided by the system 8. For example, “CT Upper Extremity” is a CPT4 based procedure that is acceptable for applying appropriateness criteria, however this type of high-level procedure is not deemed orderable. A more appropriate orderable procedure could be “CT Wrist”, which is still covered under the “upper extremity” CPT4, but much more granular. Accordingly, the validation indicator 15 that is generated by the system 8 can also include comments as to whether the requested exam/procedure 13 is orderable or not.

The patient related definitions 102 can include patient information such as but not limited to: patient age; patient sex; and/or other patient characterizing information (e.g. health condition). In terms of Age, this can be specified to great specificity, since some definitions 102 are only useful for neonates, and others only for geriatrics. On the other hand, one can take a simpler approach and distinguish age at a much lower granularity. For example, the key distinction seems to be between pediatric age (birth to about 16 years) and adult age (greater than 16 years), however other age granularities can be used as desired, either numeric or descriptive (e.g. newborn, preschool, pre-teen, teenager, adult, middle age, etc). In terms of other Patient Health Factors, several factors may be relevant if they are available, such as pregnancy status and whether menopause has been reached. The medical practitioner related definitions 102 could be used to specify whether each user (e.g. requester of the examination/procedure 13) is a physician, and if so, whether they are a specialist of any kind, or a general primary care physician. These medical practitioner definitions 102 can be such as but not limited to: physician; nurse; technologist (e.g. radiologist); physician sub-specialty; and/or physician type (e.g. resident, student, data entry personnel, other).

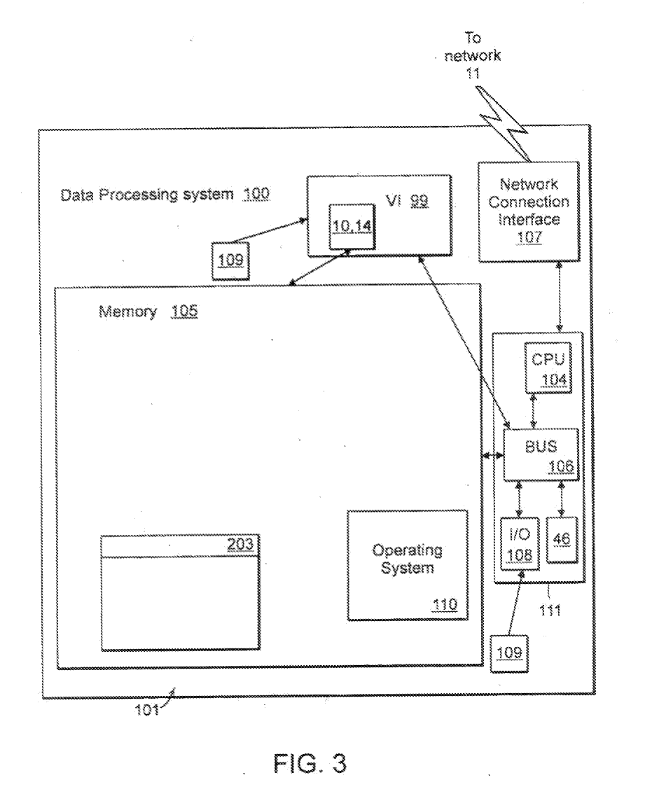

In view of the above, the definitions 102 are predefined and are included in an exam definition database 203 (see FIG. 3), from which predefined exam definitions 100 are selected for comparing against the exam data 12 of the examination request 10 received by the decision support system 8. The definitions 102 (e.g. questions on symptoms, diseases, and other patient info useful in facilitating subsequent patient 20 treatment) can be considered as potential reasons for doing the examination 13 as requested by the medical practitioner 18.

It is recognized that the definitions 102 (e.g. indications) can be any piece of information that is clinically relevant to the treatment or testing (e.g. exam 13) being considered for the patient 20. We can say that a diagnostic test is “indicated” if the patient information collected with respect to the definitions/indications 102 make it appropriate that the test be done under the circumstances. Accordingly, each of the definitions 102 can be a question, answer to a question, topic, sentence, phrase, circumstance, menu selection (or other content 112,114,116—see FIG. 4, as desired). The definitions 102 can point to or show the cause, pathology, treatment or issue of an attack of disease and/or that which serve as a guide or warning. The definitions 102 can be configured in the exam request 10 so as to facilitate the collection of clinical information pertaining to one or more potential diagnostic procedures applicable to the patient 20.

Further, it is recognized that the definitions 102 can be given in terms of the signs or symptoms of the patient 20. The physician 18 can observe the signs, such as that the patient 20 has a cough. Symptoms can be subjectively perceived, such as pain, or a change in mental state. Definitions 102 can also refer to patient history or even family history. For example, it may be useful to know that the patient 20 is known to have a tumour, or that her mother had a type of breast cancer that could be inheritable. The history of previous testing that has been done on the patient 20 is also a relevant definition 102. Definitions 102 can also refer to diseases that the physician 18 suspects or desires to rule out. Even if one does not know why the physician 18 suspects a particular disease or syndrome, knowing that they do may be relevant.

Many definitions 102 can be further defined by giving detail about various patient 20 attributes. For example, the definitions 102 about a cough could have the content of: a duration—how long has the patient been coughing?; severity—how violently do they cough?; productivity—do they cough anything up or not?; time of day—is it restricted to night time, perhaps?; and instigation—perhaps they cough only when indoors, or after a deep breath. Further examples of definitions 102 and associated information collected from the medical practitioner 18 could be exam data 12 such as but not limited to: patient age in days (for patients under the age of 1); pregnancy status; specific allergy values; and/or specific lab values and other prior exam/test results.

It is also recognized that if the definitions 102 could be used to specify what could not possibly apply to the medical circumstances/conditions of the patient 20, For example, if the patient 20 is a baby boy with a head injury, the inclusion of the definition 102 “premature menopause” would be considered by the decision support system 8 in determining the validation indicator 15, as further described below.

Further, definitions 102 can come in different categories, see FIG. 7 by example, such as but not limited to: Sx (Signs and Symptoms); Hx (History); Ddx (Differential Diagnosis); and other reasons, such as a pre-operative study, or to stage and restage cancer—for example. Some of the definitions 102 can have additional structure to give details about some aspect of the patient 20. For example, the definition 102 of “pain” may also be provided structure in the exam request 10 to facilitate the medical practitioner 18 to specify the duration and location of the pain, as communicated by the patient 20 or otherwise identified/surmised by the medical practitioner 18.

It is recognised that the definitions 102 can be based on the following example sources, such as but not limited to:

1) orders that were created by allowing the user to enter free text statements can be mined to find commonly-used statements;

2) ordering physicians and radiologists can be canvassed as they know by experience what statements they tend to use or see, this canvassing can be done in response to user feedback and/or content analysis of the received exam requests 10 themselves;

3) published decision support guidelines can be useful sources of statements because the guidelines define clinical conditions under which clinical advice can be provided. These clinical conditions can correspond to the set of statements; and

4) other published medical literature can be a source. Definition 102 Types/Concepts

Referring again to FIGS. 1 and 2, the various types of definitions 102 in the database 203 can pertain to, for example such as but not limited to: modality; body part; body system; procedure type/modifier; specialty; sex; age; and other patient health factors. Further, it is recognised that the definitions 102 can be classified according to a concept category, such as but not limited to: patient information (e.g. age, sex, health related); medical practitioner specialty; and exam information (e.g. modality, body part, body system, etc.).

Examples of the modality can include a course-grained distinction of six modalities, for example: [0047] X-ray (applicable to identification of skeletal trauma/characteristics); CT (applicable to identification of skeletal and soft tissue trauma/characteristics); MRI (applicable to identification of soft tissue trauma/characteristics); Radiofluoroscopy; Ultrasound; and Nuclear Medicine.

Examples of the procedure type (e.g. of the specified exam 13 and/or the suggested alternate procedure) can be such as but not limited to: Consult; Diagnostic; Interventional; Screening; Therapeutic; Treatment; and Planning.

Examples of the body parts can include selected body parts forming a hierarchy, wherein some body parts can be divided into subparts (to the right and down):

TABLE-US-00001 Head Orbit Sinus Mastoid Nasal Bones Neck Cervical Entire Spine Thoracic Lumbar Sacral Chest Sternoclavicular Joint Sternum Ribs Heart Breast Appendix Abdomen Pelvis and Pelvis Scrotum Hip Hip Extremities Upper Shoulder Glenohumeral Joint Scapula Brachial Plexus Acromioclavicular Joint Clavicle Humerus Elbow Forearm Wrist Hand Thumb Fingers Lower Femur Knee Tibia/Fibula Ankle Foot

Another embodiment of the body parts/regions can be such as but not limited to: Head—Skull, Brain, Eye, Ear; Neck; Torso—Chest, Breast, Abdomen, Pelvis; and Extremities

Examples of body systems can be: musculoskeletal; cardiovascular; neurologic; urologic; lymphatic; respiratory; gastrointestinal; endocrine; and reproductive.

Examples of specialties could be divided into the following, and possibly others: Cardiology; Endocrinology; Gastroenterology; General Surgery; Gynecology; Hematology; Nephrology; Neurology; Neurosurgery; Oncology; Ophthalmology; Orthopedic Surgery; Otolaryngology (ENT); Plastic Surgery; Radiology; Respirology; Rheumatology; and Urology.

Further, it is recognised that one could distinguish any specialty from general practice. Accordingly, in view of the above, it is recognised that the definitions 102 can used to collect patient 20 related information on any of the above discussed example types/concepts of exams/procedures 22.

### Advice Session 300

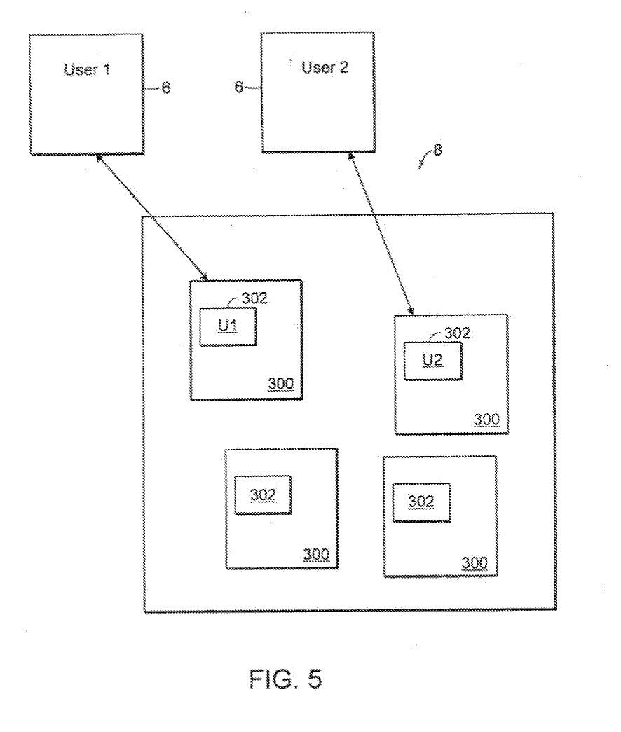

Referring to FIG. 5, shown is an example structure of the interaction between the system 8 and the client 6 for processing of the exam requests 10 and subsequent delivery of the exam response 14. Each interaction with the Decision Support system 8 can be associated with an advice session 300, which can be described as a container for a single requisition/order validation that is stored (or otherwise persisted) in the database 203 (see FIG. 2). The session 300 stores the data 12 that describes the clinical condition being validated. Each requisition/order 10 being validated has one related session 300. Preferably, although it is possible to clear a session 300 from the database 203, sessions 300 are not be reused for multiple orders 10. For example, User 1 has a session 300 with the session ID “U1” and User 2 has a session 300 with the session ID “U2”, such that U1 is unique to the session 300 for User 1 and U2 is unique to the session 300 for User 1.

Further, the Advice Session 300 is configured as a workspace that contains the data 12 that is passed to the matching module 202 and/or interaction module 206 for processing. The system 8 facilitates the addition and removal of the exam data 12 in this workspace as the user (of the client 6) interacts with the system 8. Further, each session 300 is identified by a session ID 302. The session ID 302 can be any unique string value (e.g. alpha, numeric, alpha-numeric) that is used to label or otherwise identify uniquely the respective session 300 of the user. The Decision Support system 8 can generate the session IDs 302 and/or the clients 6 of the system 8 can provide a unique value for use as the session ID 302. The session ID 302 could be a string UUID that is stored as an attribute of the requisition/order 10. Alternatively, the unique identifier 302 of the requisition/order 10 that already exists (in the database 203) could be used as the session ID 302, as supplied by the client 6 to the system 8 in order to access the requisition/order 10 in the state of being processed (i.e. the order 10 that has been submitted to the system 8 but has not yet been finally reported to the client in the form of a final exam response 14). The session ID 302 is may be a UUID or GUID. Each session 300 is established by the system 8 even if only a single Request Advice call (e.g. exam request 10) is received. Additional clinical condition attributes can be added to the session 300 at any time (e.g. with interaction of the client 6 with the interaction module 206—see FIG. 2). As the clinical condition in the session 300 changes, further Request Advice calls may produce different advice (e.g. changes may be made to the most recently generated validation indicator 15 associated with processing of the most recent exam data 12 associated with the received exam request 10).

When advice is requested, via the exam request 10, the system 8 applies the current set of content 112,114,116 (see FIG. 2) against all clinical condition attributes (e.g. exam data 12) stored in the session 300. The system 8 may not make any assumptions that is has interacted with the session 300 previously. Because of the dynamic relationship between Advice Session 300 and content of the exam request 10 (initial data 12 and/or updated data 12 via the questions 17 and answers 19—further described below), a number of interaction scenarios are possible, for example: Changing Condition and Changing Content.

For Changing Condition, the following example steps are performed by the system 8: 1) the client 6 calls Submit Clinical Condition, e.g. exam request 10, which causes the respective session 300 to be created and the procedure (e.g. exam 13) and indications (e.g. data 12) provided to the session 300 are stored in the database 203; 2) the client 6 calls Request Advice and gets an Inappropriate status (i.e. validation indicator 15); 3) The client 6 calls Submit Clinical Condition again, this time passing in some additional indications (i.e. further information 19) and this information 19 is added to the existing session 300; and 4) the client calls Request Advice again, but this time gets an Appropriate status (i.e. validation indicator 15) because of the additional indications 19 submitted. Accordingly, subsequent calls to Request Advice can return different advice if the clinical condition session data changes.

A second interaction scenario is Changing Content, where the following example steps are performed by the system 8: 1) The client 6 calls Submit Clinical Condition, i.e. exam request 10, which creates the session 300 and stores the procedure 13 and indications 12 provided to the session 300 in the database 203; 2) the client 6 calls Request Advice and gets an Inappropriate status indicator 15; 3) the content update is applied by the system 8, changing the logic of some rules of the content 112,114,116 (see FIG. 2); 4) the client calls Request Advice (using the session ID 302) again without changing any clinical condition data 12, but this time gets an Appropriate status indicator 15 because the content has changed. Accordingly, subsequent calls to Request Advice can return different advice if the content changes, which means that the content 112,114,116 preferably should be applied in full to existing clinical condition data 12.

Accordingly, in view of the above described session 300 and session ID structure of the client 6-system 8 network interactions, the Decision Support system 8 may be stateless in its processing of the exam data 12 and subsequent generation and reporting of the validation indicator 15 to the client 6. That is, the system 8 may not store any of the advice session 300 or advice data 12 in memory 102 (see FIG. 3) for the purpose of maintaining state between session calls (i.e. submission of exam requests 10 or the updates of the data 12 for previously submitted exam requests 10). In this case, the use of the session ID 302 provides for the session 300 state to be stored to and retrieved from the database 203 on every client 6 call to the system 8, wherein the session 300 pertains to the same initially submitted exam request 10 and any data 12 updates thereto.

It is recognised that the above described interaction between the system 8 and the client 6 can be implemented as synchronous communication over the network 11 or as asynchronous communication, as appropriate. In the event of asynchronous communication, the session ID 302 can be used to maintain continuity between the different access periods of the session 300.

It is recognised that synchronous communication can be described as direct communication, where all parties involved in the communication are present at the same time (an event). For example, the data transfer method of synchronous communication is such that a continuous stream of communication data signals (i.e. communication of exam requests 10 and respective responses 14) can be accompanied by timing signals (generated by an electronic clock) to provide that the transmitter (of either the system 8 or the client 6) and the receiver (of either the client 6 or the system 8) are in step (synchronized) with one another. The communication data can be sent in blocks (called frames or packets) spaced by fixed time intervals. On the contrary, asynchronous communication does not require that all parties involved in the communication need to be present and available at the same time. Asynchronous transmission works in spurts and inserts a start bit before each data character and a stop bit at its termination to inform the receiver where the communication begins and ends. As well, the session ID 302 can be included in the requests/responses 10,14 for asynchronous communications.

### Computer Devices 101

### Data Processing System 100

Referring to FIGS. 1 and 3, each of the components of the system 8 and associated components (e.g. the client 6 and/or the third party server 7—see FIG. 9) can be implemented on one or more respective data processing systems 100 of computing device(s) 101, in order to facilitate interaction with the exam requests 10 and responses 14 displayed on a visual interface 99. The data processing system 100 for the client 6, for example, has a user interface 108 for facilitating interaction with the system 8 by the user, the user interface 108 being connected to a memory 105 via a BUS 106 of a device infrastructure 111. The interface 108 is coupled to a processor 104 via the BUS 106, to interact with user events 109 to monitor or otherwise instruct the operation of the client 6 via an operating system 110. The user interface 108 can include one or more user input devices such as but not limited to a QWERTY keyboard, a keypad, a trackwheel, a stylus, a mouse, and a microphone. The visual interface 99 is considered the user output device, such as but not limited to a computer screen display. If the screen is touch sensitive, then the display can also be used as the user input device as controlled by the processor 104. Further, it is recognized that the data processing system 100 can include a computer readable storage medium 46 coupled to the processor 104 for providing instructions to the processor 104. The computer readable medium 46 can include hardware and/or software such as, by way of example only, magnetic disks, magnetic tape, optically readable medium such as CD/DVD ROMS, and memory cards. In each case, the computer readable medium 46 may take the form of a small disk, floppy diskette, cassette, hard disk drive, solid-state memory card, or RAM provided in the memory 105. It should be noted that the above listed example computer readable mediums 46 can be used either alone or in combination.

Further, it is recognized that the configured computer device 101 is an example embodiment of the system 8 (including subsequent coordination of medical practitioner 18 interaction with the exam requests 10 and responses 14 and processing thereof), which can contain a number of modules for implementing the various attributes and functionality associated with processing and/or interaction of the system 8 with the client 6, as described with reference to the Figures.

The devices 101 include a network connection interface 107, such as a network interface card or a modem, coupled to the device infrastructure 111. The connection interface 107 is connectable during operation of the devices 101 to the network 11 (e.g. an intranet and/or an extranet such as the Internet), which enables the devices 101 to communicate with each other, the medical practitioners 18, and with the associated third party servers 7 (see FIG. 9), is so configured, for coordinating the exam request 10 processing and generation of the appropriate exam response 14 with validation indicator 15. Referring again to FIG. 3, operation of the devices 101 is facilitated by the device infrastructure 111. The device infrastructure 111 includes one or more computer processors 104 and can include an associated memory 105 (e.g. a random access memory). The computer processor 104 facilitates performance of the device 101 configured for the intended task through operation of the network interface 107, the user interface 108 and other application programs/hardware of the device 101 by executing task related instructions. These task related instructions can be provided by an operating system, and/or software applications (e.g. the modules 200, 202, 204, 206, 208—see FIG. 2) located in the memory 105, and/or by operability that is configured into the electronic/digital circuitry of the processor(s) 104 designed to perform the specific task(s) related to generation and/or interaction with the request 10, response 14 processing, as desired.

Referring again to FIG. 3, the devices 101 as the client 6 are configured for presenting the exam request 10 and exam response 14 on the visual interface 99. The device 101 also interacts with data from data files or tables of the memory 105. It is recognized that the data could be stored in the same or separate tables, as desired. The device 101 as the system 8 can receive requests 10 (see FIG. 1) for storing, retrieving, amending, or creating the appropriate responses 14, as driven by the user events 109 (e.g. update data 12 via questions 17 and answers 19) and/or independent operation of the device 101. Accordingly, the device 101 is configured to coordinate the processing of the data 12 and user events 109 with respect to the content of the exam requests 10/responses 14.

Further, it is recognized that the computing devices 101 can include the executable applications comprising code or machine-readable instructions for implementing predetermined functions/operations including those of an operating system, for example. The processor 104 as used herein is a configured device and/or set of machine-readable instructions for performing operations as described by example above. As used herein, the processor 104 may comprise any one or combination of, hardware, firmware, and/or software. The processor 104 acts upon information by manipulating, analyzing, modifying, converting or transmitting information for use by an executable procedure or an information device, and/or by routing the information with respect to an output device. The processor 104 may use or comprise the capabilities of a controller or microprocessor, for example. Accordingly, any of the functionality of the system 100 may be implemented in hardware, software or a combination of both. Accordingly, the use of a processor 104 as a device and/or as a set of machine-readable instructions is hereafter referred to generically as a processor/module for sake of simplicity. Further, it is recognised that the system 100 can include one or more of the computing devices 101 (comprising hardware and/or software) for implementing the modules, as desired. These modules can include modules such as but not limited to the modules 200, 202, 204, 206, 208 as further described below.

It will be understood that the computing devices 101 may be, for example, personal computers or workstations. Further, it is recognised that each device 101, although depicted as a single computer system, may be implemented as a network of computer processors, as desired.

### Memory 105

The memory 105 can be used to store the exam definition database 203 for the decision support system 8. The definitions 102 (e.g. Clinical Content) of the database 203 can be a set of encoded electronic guidelines that are focused on the clinical and/or fiscal validation of the requested exam 13 received in the examination request 10 (along with the supporting exam data 12) in an effort to maintain a standard of care. Use of the definitions 102 by the decision support system 8 can be implemented as clinical validation guidelines that can be used to facilitate the chance of a relevant diagnosis of the patient 20 defined by the exam data 12, and to help increase the usefulness of each result of the specified exam 13 once conducted. Referring to FIG. 4, shown is an example exam definition database 203 having definitions 102 that include exam definitions 100 that are associated to specific exam types 22. For example, included are universal/global definitions 120 that can be applied to all clients 6 that submit exam requests 10 to the decision support system 8 and local definitions 121 that can be used for selected one(s) of the clients 6 submitting the exam requests 10. For example, the definitions 102 can include appropriateness content 112, fiscal content 116, and decision support content 114.

For example, the appropriateness content 112 can provide a first level/stage form of validation (scoring) addressing the more obvious cases of contraindicated examination requests/orders 10 using procedure (CPT4) to indication (ICD9) scoring, in comparison of the exam data 12 with the definitions 102 of the content 112 in the database 203. Further, the decision support content 114 can be a second level/stage form of interactive validation, including more granular indications/definitions 100 and the ability to ask the user (of the client 6) questions 17 that clarify the clinical condition described in the exam data 12 of the exam request 10. This content 114 can provide additional value by addressing specific clinical conditions/definitions 100 that would otherwise fall in the grey area of “moderate utility”. This content 114 can also address cases where orders may be seen as inappropriate when first processed using the content 112, but are actually appropriate given the full detail of the clinical condition in response to the questions 17 in interaction of the client with the an interaction module 206 of the decision support server 8 (see FIG. 2). Further, the fiscal content 116 can managed as part of the local content 121, and provides a fiscal content guideline that facilitates to maintain or increase reimbursement by increasing the awareness of potential reasons for denial, thus facilitating a positive relationship between Radiology Providers, Physicians, and third party payors (not shown).

It will be understood by a person skilled in the art that the memory/storage 102 described herein is the place where data is held in an electromagnetic or optical form for access by the computer processor 104. There can be two general usages: first, memory is frequently used to mean the devices and data connected to the computer through input/output operations such as hard disk and tape systems and other forms of storage not including computer memory and other in-computer storage. Second, in a more formal usage, memory/storage 105 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is one embodiment of memory 105 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases can contain aggregations of data records or files, such as patient 20 info, exam types 24, definitions 102, and practitioner 18 profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 105 can also be defined as an electronic holding place for instructions and data that the computer's microprocessor 104 can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

### Decision Support System 8

Referring to FIGS. 1 and 2, the system 8 provides access to Clinical Decision Support for Diagnostic Imaging, for example. The system 8 stores or otherwise processes clinical condition data (e.g. exam data 12), such as the requested procedure 13 and definitions 102, to a respective session 300 (see FIG. 5) of a respective client 6 user. The system 8 can associate the respective session ID 302 (optional) with the examination request 10, in association with generating a validation indicator 15 (e.g. advice of the exam response 14) in response to the validation request 10. The session ID 302 can be an alpha, numeric, or alpha-numeric ID, as desired. For example, the session IDs 302 can be unique for each clinical condition being analyzed (for example, each DI Requisition has a unique session ID 302). The session ID 302 can be a GUID that is stored with the requisition or order request 10. Or, the session ID can be the requisition/order ID itself, as desired. Further, it is recognised that the session ID 302 can be assigned to the session 300 by the system 8 (in this case also communicated to the client 6 by the system 8 once assigned) and/or by the user of the client 6. As further discussed below, the session ID 302 can be used (i.e. communicated by the client to the system 8) subsequently (after submission of the exam request 10) to retrieve the respective exam response 14, associated with the session 300 via this assigned session ID 302, i.e. from the system 8.

In some cases, the response 14 can contain additional questions 17 (see FIG. 2) to ask of the user. The answers 19 to these questions 17 are also considered part of the clinical condition, and can be stored to the session 300 to complete the advice interaction of the user (via the client device 6 over the network 11) with the system 8. In this case, the assigned session ID 302 can be used by the client 6 to obtain the response 14 from the system 8, to facilitate receipt of the questions 17, and to associate the respective answers 19 with the session 300. For example, repeated calls can be made by the client 6 to the system 8 using the same session ID 302, such that new procedures/information 12,13 are added to the existing clinical condition (e.g. exam data 12) of the session 300. Further, duplicate values associated with the session ID 302 are updated in the session 300 by the system 8.

The system 8 has a receipt module 200 for receiving from a user (e.g. medical practitioner 18 requesting the examination 10) those data 12 (e.g. assigned clinical definitions 102 and associated patient information 11) of the selected examination type 22, patient 20, and/or medical practitioner 18. The data 12 is used by a matching module 202 for comparison against the exam definitions 100 associated with the specified exam 13 (is present) as well as the definitions 100 of other potential exam types 22, in order to determine the validation indicator 15 appropriate for the exam request 10. A response module 208 is used to report the exam response 14 to the client 6. The system 8 can also have an interaction module 206 for coordinating the update of the exam data 12 through the provision of questions 17 and receipt of corresponding answers 19, as further described below. The system 8 can also have an outcome capture module 204 for monitoring the outcomes of the exam request 10 and exam response 14 communications with the medical practitioner(s) 18 of the client 6.

### Receipt Module 200

Referring again to FIGS. 1 and 2, the receipt module 200 can be part of the network connection interface 107 (see FIG. 3) of the device 101 operating the system 8. The module 200 can communicate synchronously or asynchronously with the device 101 of the client 6 over the network 11. The receipt module 200 can receive some or all of the exam data 12 from the user. For example, the user can supply the name of the medical practitioner 18 requesting the exam 10, the name of the patient 20, and the exam type 22 to the receipt module 200. The system 8 could then access an administration database (e.g. memory 105) to supplement further details (applicable definitions 102) about the patient 20, medical practitioner 18, and/or exam type 22 as necessary to collect all definitions 102 needed for generating an appropriate validation indicator 15.

For example, the medical practitioner 18 as a general practitioner (e.g. no specialty) could submit the data 12 to the system 8, in order to receive the validation indicator 15 for the desired exam 13. For example, suppose the general practitioner 18 orders a chest X-ray 13 for a male newborn 20. This information can be represented by the following definitions 102: patient name—John Doe; age—newborn; sex—male; specialty—none; modality—X-ray; body-part—chest; and body-system(s)—musculoskeletal, cardiovascular, and/or respiratory. Any supplemental information can be obtained from the memory 105 by the system 8 (e.g. any previously stored relevant details concerning the delivery of the newborn—e.g. premature, physical deformities, etc.—for example as identified or otherwise associated with the same session ID 302). This supplemental information of the patient 20 can be stored in the memory 105 in the form of predefined definitions 102 and/or as descriptive patient information. For example, the patient John Doe could also have the additional definitions 102 of “birth weight=four pounds” and the description of “potential lung infection” in the electronic patient file associated with the patient 20 name (John Doe) and/or with the session ID 302. Accordingly, in the above example, the data 12 available to the receipt module 200 would include: patient name—John Doe; age—newborn; sex—male; specialty—none; modality—X-ray; body-part—chest; and body-system(s)—musculoskeletal, cardiovascular, and/or respiratory; birth weight—four pounds; and potential lung infection.

The receipt module 200 makes the data 12 available to the matching module 202 and/or the interaction module 206, as configured by the system 8. The receipt module 200 can have an optional request queue 201 (e.g. as part of the memory 105) for temporarily storing the received exam requests 10, for subsequent access by the matching 202 and/or interaction 206 modules.

It is recognised that this module 200 (or in conjunction with the response module 208, for example) can facilitate the receipt of the initial exam request 10 (e.g. a preliminary request) that includes a number of parameters that facilitate the definition of the clinical procedure desired/suggested by the medical practitioner 18, for example as a number of parameters used in calling an API of the system 8. These parameters can include definitions such as but not limited to: Parameter1 Procedure Coding Scheme; Parameter2 Procedure/Exam ID; Parameter3 Session ID; Parameter4 Patient Date of Birth; Parameter5 Patient Gender; and/or Parameter6 Physician Specialty. The returns by the module 200 and/or module 208 back to the medical practitioner 18 can include structured indications (e.g. statements 16) including suggested display logic, as a list of DI Indications with UI display attributes. These indications are used to describe the clinical condition in detail. This method can useful for presenting indications on a screen for users (e.g. medical practitioner 18). In turn, the medical practitioner 18 would review and interact with the displayed indications in order to generate the corresponding exam data 12 to submit in the final exam request 10 for subsequent validation processing by the system 8. Provided is an example API method to facilitate display of the statements 16 for review by the medical practitioner 18, to facilitate collection of the exam data 12.

### Class: ClinicalCondition

### Method: GetindicationDisplayList

Parameter1: Procedure Coding Scheme

Parameter2: Procedure/Exam ID

Parameter3: Session ID

Parameter4: Patient Date of Birth

Parameter5: Patient Gender

Parameter6: Physician Specialty

Returns: Structured Indications including suggested display logic.

Summary: Provides a list of DI Indications with UI display attributes. These indications are used to describe the clinical condition in detail. This method is useful for presenting indications on a screen for users.

Next, in view of receipt of the preliminary exam request 10, the medical practitioner 18 can submit the final exam request 10, including the medical practitioner 18 supplied exam data 12. For example, the submission of the exam data 12 to the system 8 can include a number of parameters that define the clinical procedure requested by the medical practitioner 18, for example as a number of parameters used in calling an API of the system 8. These parameters can include statements 16 and exam data 12 such as but not limited to: Parameter1 Session ID; Parameter2: Procedure/Exam Coding Scheme; Parameter3 Procedure/Exam ID; Parameter4 Patient Class; Parameter5 Patient Date of Birth; Parameter6 Patient Gender; Parameter7 Physician Specialty; Parameter8 Body Part; Parameter9 Selected Indications; Parameter10 Answers to Questions asked by Advice; and/or Parameter11 Procedure/Exam Description. In response, the system 8 may not returns anything to the medical practitioner 18 (e.g. other than an acknowledgement of receipt of the final exam request 10), and then proceed to stores the provided data 12 and attributes describing the clinical condition to the respective session 300 (e.g. for use in subsequent validation processing). Provided is an example API method to facilitate display of the receipt of the exam data 12 from the medical practitioner 18 for use in associating with the respective session 300.

### Class: ClinicalDecisionSupport

### Method: SubmitClinicalCondition

Parameter1: Session ID

Parameter2: Procedure/Exam Coding Scheme

Parameter3: Procedure/Exam ID

Parameter4: Patient Class

Parameter5: Patient Date of Birth

Parameter6: Patient Gender

Parameter7: Physician Specialty

Parameter8: Body Part

Parameter9: Selected Indications

Parameter10: Answers to Questions asked by Advice

Parameter11: Procedure/Exam Description

Returns: Nothing

Summary: Stores the provided data attributes describing the clinical condition to the session.

### Response Module 208

The validation indicator 15 is the level of appropriateness, suggested action(s), and/or alternative procedure(s) provided by the Decision Support system 8, based on the clinical condition (exam data 12 and/or additional information 19) received, as the primary output of this module 208. Examples of the validation indicator 15 (e.g. Advice Status, also referred to as Clinical Score) are provided below. This value represents how appropriate the exam request 10 being validated is, namely: [0133] 0—NotValidated: Based on the clinical condition (represented by the exam data 12), the requested exam 13 does not require validation; [0134] 1—Inappropriate: The requested exam 13 is not considered appropriate based on the clinical condition described, and the available evidence (represented by the exam data 12); [0135] 2—Indeterminate: Clinical appropriateness cannot be determined based on the currently encoded clinical condition (represented by the exam data 12). More questions may be asked of the user to determine appropriateness; 3—Moderate: The requested exam 13 is considered appropriate based on the clinical condition described, and the available evidence (represented by the exam data 12). However, an alternate examination type 22 may be: marginally more effective, less complex, or may expose the patient to a lower dose of radiation; and 4—Appropriate: The requested exam 13 is considered appropriate based on the clinical condition described, and the available evidence (represented by the exam data 12), for example.

As further described below, the generated validation indicator 15 is based on the clinical condition data 12 stored in the provided session 300. For example, when questions 17 are returned, the system 8 can be configured to: 1) present the user with the questions 17 returned in the exam response 14, 2) collect the answers 19 to those questions 17, 3) add them to the clinical condition (e.g. exam data 12), 4) compare the updated exam data 12 with the exam definitions 100 to get an updated validation indicator 15, or further questions 17.

The response module 200 can have an optional response queue 210 (e.g. as part of the memory 105) for temporarily storing the processed exam responses 14, for subsequent access request (e.g. by receipt of the corresponding session ID 302 from the client 6) by the client 6 when ready to receive the exam response 14. For example, in one case, a first medical practitioner 18 can prepare and submit the exam request 10 to the system 8, as an asynchronous communication to the system 8. Subsequently, a second medical practitioner 18 (for example different or the same from the first medical practitioner 18) can then submit the session ID 302 to the system 8 in order to retrieve the respective exam response 14, i.e. asynchronously with respect to the submission of the exam request 10). As an example, the first medical practitioner 18 can be responsible for data 12 collection (e.g. an intern) with respect to the patient and submission of the initial exam request 10 while the second medical practitioner 18 (e.g. a physician) can be responsible for ultimately signing/submitting the requisition order for the validated exam (e.g. either the exam 13 or the alternative exam 22). This separation of data collection duties from the signing/submitting of the actual examination order can have a benefit of workflow allocation from the perspective of the physician.

### Matching Module 202

Referring to FIGS. 1 and 2, the matching module 202 communicates with the exam definition database 203 to access exam definitions 100 (part of the stored definitions 102) that are relevant to the exam request 10, which includes the exam data 12 describing the fact situation of the patient 20 and the selected exam 13 (optionally). The matching module 202 is configured to determine a degree of match of the exam data 12 (of the exam request 10) with the sets of exam definitions 100 that are assigned in the database 203 to each examination type 22 (including the exam type for the selected exam 13). Based on matching of the exam data 12 with the exam definitions 100, the matching module 202 generates an exam validation response 14, further described below, which includes a validation indicator 15 such as but not limited to: confirmation of selected exam 13 as correct/recommended; confirmation of selected exam 13 as appropriate/recommended but not ideal; designation of selected exam 13 as not appropriate/recommended/invalid; and/or suggestion of alternative exam type(s) 22, as desired.

It is recognised that the exam definitions 100 can be resident in the database 203 as individual definitions 102 and/or as a group of definitions 102, as desired. For example, in the extreme, all applicable definitions 100 for a desired examination type 22 can be stored in the database 203 as a definition 100 group (e.g. a definition group having an assigned list of individual definitions 100 for a particular exam type 22). It is recognised that the degree of matching can include the inclusion/exclusion of specific exam definitions 100 (e.g. presence of “male” vs. “female”) and/or whether a specified value of the exam data 12 when compared to the matching exam definition 100 lies inside/outside a specified value range (e.g. specified “age=21” determined as within an age range “greater than 15”). Accordingly, the matching module 202 determines the degree of match of the exam data 12 with the exam definitions 100 assigned to each of the exam types 22 in the database 203. A match threshold 104 (or plurality of match thresholds) are associated with each of the exam types 22, such that the degree of match is measured against these match thresholds 104. Examples of the match thresholds 104 can include thresholds such as but not limited to: the exam data 12 containing a specified number/percentage of the exam definitions 100 for a respective exam type 22; the exam data 12 having presence of specific definition(s) 100 (e.g. presence in the exam data 12 of a “male” definition 100 for a selected exam 13 of a prostate X-ray); and/or exam data 12 value(s) that matches selected definition(s) 100 that fall(s) within specified value ranges.

In reference to operation 700 of the system 8 provided below, further examples of the operation of the matching module 202 are provided.

### Interaction Module 206

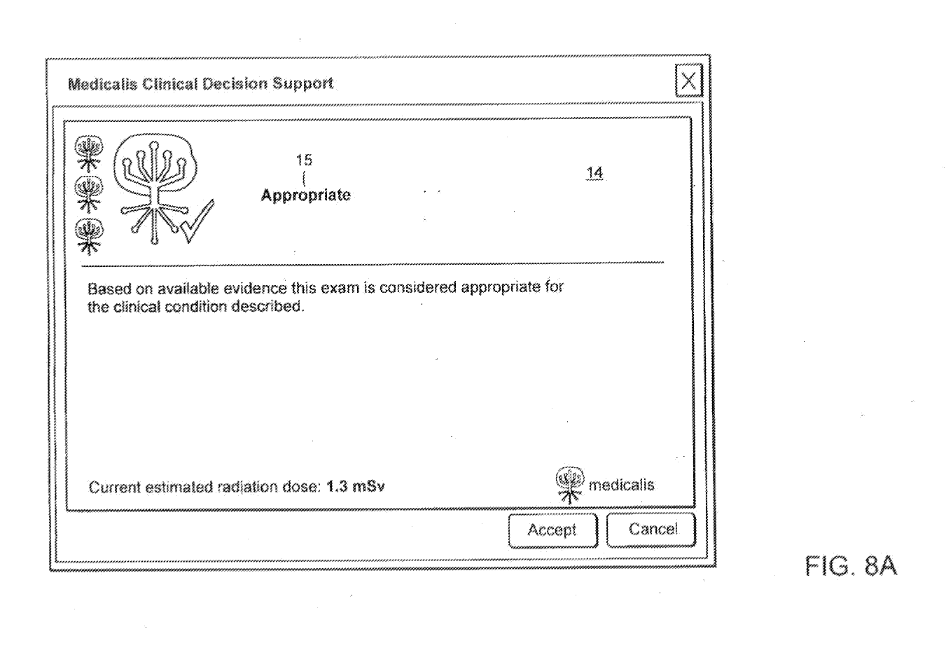

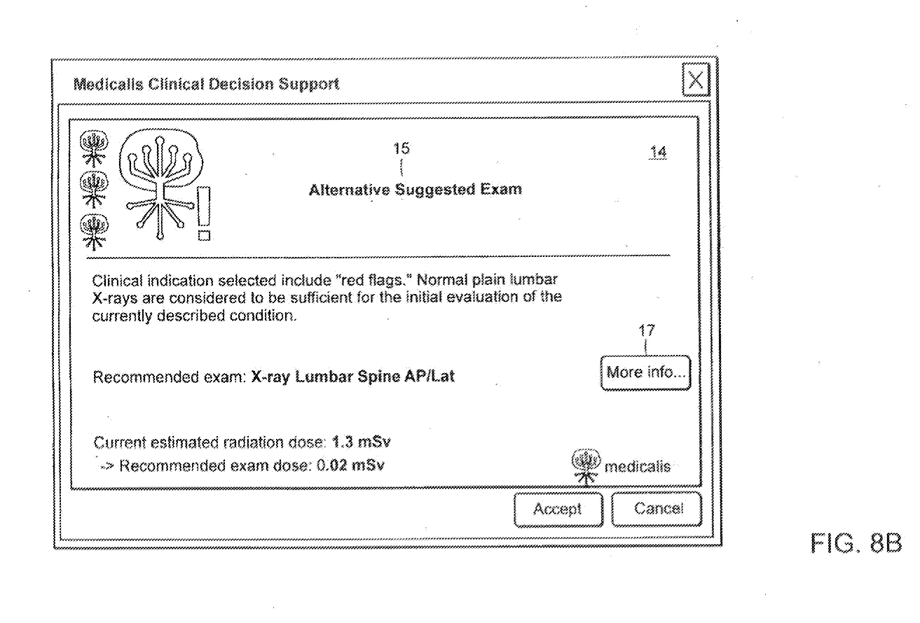

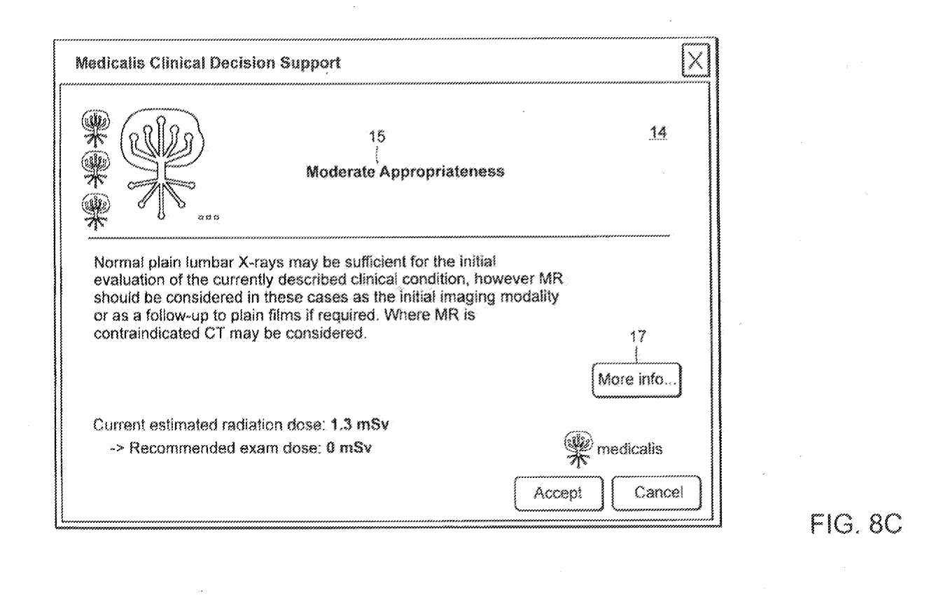

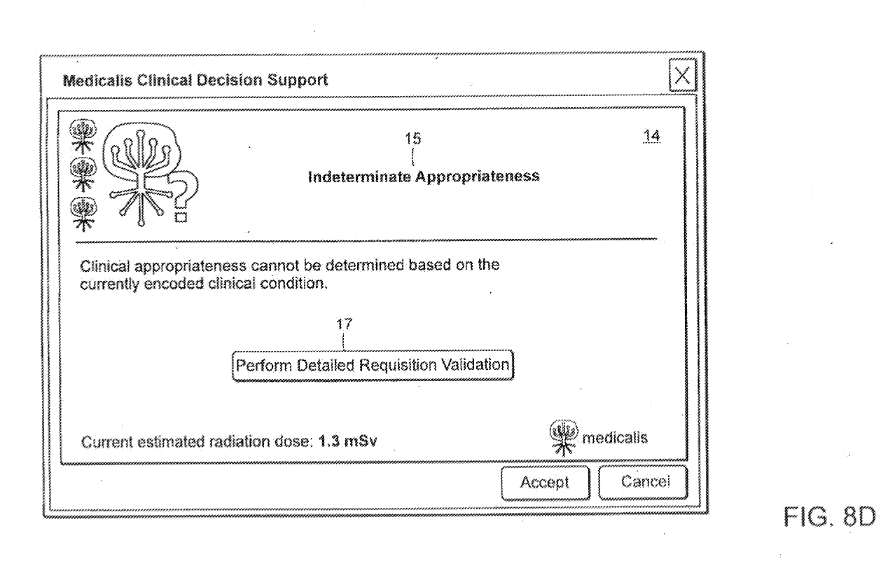

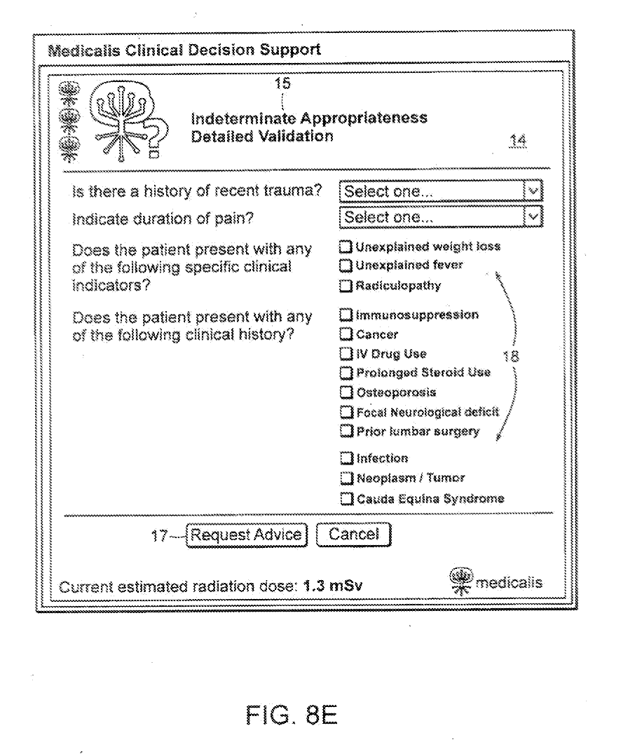

When the requested exam 13 is not deemed appropriate by the matching module 202, the client 6 for receiving Decision Support can invoke the interaction module 206. Here the interaction module 206 gathers more granular structured data 12 from the user through questions 17 that is generally beyond the level of the indication form 9. Examples of the validation responses 14 are shown in FIGS. 8a,b,c,d. It is recognised that a user event 17 (e.g. a UI button or other UI control) can be used to launch the interactive module 206 as described below. The interaction module 206 uses the appropriateness content 114 of the definitions 102 to obtain further exam information 19 (e.g. additional exam data 12 as a response to the questions 17) from the user of the client 6, in order to facilitate the generation of an appropriate indicator (i.e. validation indicator 15) for either the requested exam 13 or an alternative examination type 22, based on a comparison of the exam information 19 and the original exam data 12 (if applicable) with the exam definitions 100. Accordingly, if some content 114 applies, and the result is not Indeterminate, advice is presented in the advice session to the user. Lastly, if no definitive advice has been presented, Appropriateness Content 112 can be used to provide the best possible alternative procedure in substitution for the requested exam 13.

The Decision Support Content 114 is used by the interaction module 206 when the appropriateness content 112 cannot provide definitive appropriateness of the requested exam 13. The content 114 facilitates the collection of further information 19 from the user in response to questions 17 based on the content 114. This content 114 is capable of being used to ask the user questions 17 that will help gather the additional structured data as information 19 that can be used to supplement or otherwise replace the initially supplied exam data 12. The further information 13 is compared to the exam definitions 100 of the content 114 to change the initially provided validation indicator 15 (having a value other than appropriate), to provide suggested alternative exam types 22, and/or to provide customized advice text in the examination response 14 that can be used to educate the user on the proper use of the requested exam 13 (and/or the suggested alternative exam type(s) 22). Decision Support rules of the content 114 can be capable of: 1) evaluating the requested exam 13 and the entire clinical condition (e.g. represented by the exam data 12) stored in the Advice Session; 2) changing the appropriateness score (e.g. AdviceStatus) for the advice session; 3) supporting the following logical expressions of AND, OR, NOT, EQUAL, GREATER THAN, LESS THAN; 4) providing a suggested alternative exam type(s) 22; 5) firing, or not firing, based on the answer 19 to the question 17; and/or 6) providing customized Advice Text in the examination response 14.

Further, it is recognised that each time advice is requested from the content 114, all Decision Support rules covering the clinical condition in the advice session can be applied, even if they were applied in a previous call. This means Decision Support rules may not assume that another rule has already fired. However, rules may be skipped if an answer 19 for the associated questions 17 has already been stored in the advice session. As noted above, if the Decision Support content 114 does not have an applicable rule for the condition described by the exam data 12 in view of the requested exam 13 (or suggested alternative from the content 112), then the highest applicable score from the appropriateness content 112 is returned in the exam response 14, including any suggested alternative examination types 22 and canned advice text.

It is recognised that the interaction module 206 can be invoked by the client after submission of the appropriate session ID 302 to the system 8, in order to obtain the corresponding exam response 14 pertaining to a previously submitted exam request 10.

For example, the submission of the questions/answers 17,19 by the medical practitioner 18 can include a number of parameters that define the clinical procedure requested by the medical practitioner 18, for example as a number of parameters used in calling an API of the system 8. These parameters can include statements 16 such as but not limited to: Parameter1 Session ID; Parameter2 Procedure/Exam Coding Scheme; Parameter3: Procedure/Exam ID; Parameter4 Patient Class; Parameter5 Patient Date of Birth; Parameter6 Patient Gender; Parameter7 Physician Specialty; Parameter8 Body Part; Parameter9 Selected Indications; Parameter10 Answers to Questions asked by Advice; and/or Parameter11 Procedure/Exam Description. The return communication (e.g. questions 17 or answers 19) in response to receipt of the above listed parameters by the module 206 can include Advice (e.g. answers 19) based on the stored clinical condition of the session 300. The advice can contain answers 19 content such as but not limited to: Advice Text (e.g. instructions for the clinician); Session Status (the appropriateness indicator 15); Requested Procedure/Exam 13 (e.g. the procedure that is being validated); Recommended Procedure(s) (e.g. any alternative suggested procedures that may be more appropriate or effective); Actions (e.g. a list of actions the clinician can perform based on the advice such as IGNORE ADVICE, or CHANGE EXAM TO ALTERNATE); Supporting Information about the advice; and/or Questions (e.g. questions for the clinician to answer so the engine 8 can provide more accurate advice). Accordingly, the requests advice from the decision support system 8 can be based on the existing clinical condition data 12 stored in the provided session 300. Any new clinical condition data 12 provided can be added to the session 300 before advice (e.g. answers 19) is given to the medical practitioner 18 by the system 8. Provided is an example API method to facilitate display requesting of advice by the medical practitioner 18 and subsequent delivery of the advice by the system 8 for validation processing of the exam data 12 of the respective session 300.

### Class: ClinicalDecisionSupport

### Method: RequestAdvice

Parameter1: Session ID

Parameter2: Procedure/Exam Coding Scheme

Parameter3: Procedure/Exam ID

Parameter4: Patient Class

Parameter5: Patient Date of Birth

Parameter6: Patient Gender

Parameter7: Physician Specialty

Parameter8: Body Part

Parameter9: Selected Indications

Parameter10: Answers to Questions asked by Advice

Parameter11: Procedure/Exam Description

Returns: This method returns Advice based on the stored clinical condition. The advice will contain: Advice Text (instructions for the clinician), Session Status (the appropriateness indicator), Requested Procedure/Exam (the procedure that is being validated), Recommended Procedure(s) (any alternative suggested procedures that may be more appropriate or effective), Actions (a list of actions the clinician can perform based on the advice such as IGNORE ADVICE, or CHANGE EXAM TO ALTERNATE), Supporting Information about the advice, and Questions (questions for the clinician to answer so the engine can provide more accurate advice). Summary: Requests advice from the decision support engine based on the existing clinical condition data stored in the provided session. Any new clinical condition provided will added to the session before advice is given.

### Outcome Module 204

Referring to FIG. 2, the system 8 can also implement the outcome module 204. For example, the module 204 can provides access to the outcome capture services of the Decision Support system 8. The module 204 stores the outcome of an advice session 300 in the database 203, including for example additional demographic data (e.g. of the patient 20, the practitioner 18, the client 6 such as representing a specific health care facility, etc.) related to the order/requisition 10. These demographic values can be used for heuristics and also for reporting. The processes of the module 204 use the existing session ID 302, in order to associate the captured outcome with the respective exam request 10, to facilitate organizations to analyse the effectiveness of decision support in their environment 5. The module 204 can store and manage the following data elements, for example: Action Taken (by user); Chosen Procedure; Physician ID and Name (e.g. for reporting purposes only); and Patient ID (e.g. for heuristic purposes only). Further, the module 204 can also record other details of the advice session 300 in an advice log, used to capture the clinical condition data 12 of the exam request 10 for auditing and reporting purposes. In addition to the advice session 300, the advice log can also store data regarding what rules fired during the session 300, via the modules 202, 206, as well as what the user 6 was presented with (indications, questions, etc.). The Advice Log can be a separate entity from the advice session 300, as stored in the database 203. Further, the module 204 can be used to have a session 300 cleared and started fresh, but the associated Advice Log can be used to maintain the entire history of the session 300.

The Advice Log can be used to store the following instance data for the advice session 300 including data such as but not limited to: the Procedure Requested; the procedure description; the specific body part(s) (if provided for CPT4 procedure); the Indications presented to the user 6; selected Indications (including free text); prior imaging (Procedure History); Advice presented including Questions 17 asked (including date/time presented); Answers 19 selected by user 6 (including free text); Physician Specialty; Patient Class; Patient Age; Patient Gender; Additional clinical data (Generic Clinical Data); the session Outcome; the date/time the Advice Log was created; and the date/time the Advice Log was last modified.

In terms of Clear Operations, these can perform physical deletes of the associated data of the session 300 from the database 203. It is preferred that advice session, advice log, and billing data be stored separately in the database 203 from the other session 300 data. The system 8 may choose to clear a session 300 and start over, however the advice log can show the entire interaction including the data stored before the session 300 was cleared. Also, the system 8 may choose to clear the entire session 300 including the advice log. However the billing information for that customer can still report that the session 300 was created during that period.

It is recognised that for the above described outcome capture functionality, the outcome is not the advice that was presented, rather the outcome is the action that the user 6 took based on their interaction with the advice (i.e. what was the reaction of the user 6 to the presented validation indicator 15—e.g. did the user 6 follow the advice and use the alternative procedure?).

Provided below is an example API call for storing the outcome of the advice session 300.

### Class: Outcome

### Method: SubmitOutcome

Parameter1: Session ID

Parameter2: Action Taken (by the clinician: e.g. IGNORE ADVICE, or CHANGE EXAM TO ALTERNATE)

Parameter3: Procedure/Exam Coding Scheme

Parameter4: Final Procedure/Exam ID

Parameter5: Physician ID

Parameter6: Physician Name

Parameter7: Patient ID

### Returns: Nothing

### Example Operation of the Decision Support System 8

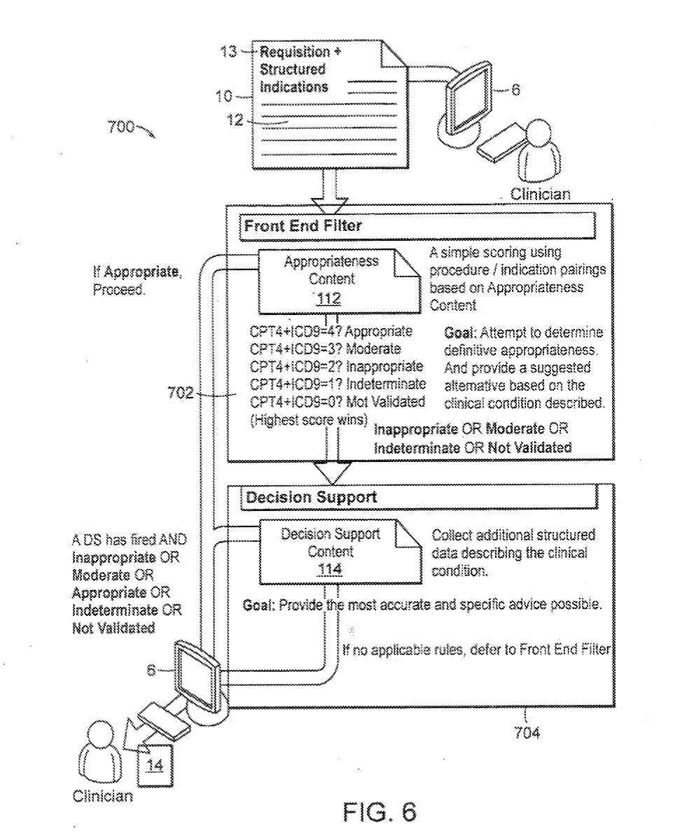

Referring to FIGS. 2 and 6, shown is an example operation 700 of the system 8, configured so as to validate the examination request 10 that includes the examination data 12 and the specified examination 13. The examination data 12 can be supplied through interaction of the user (of the client 6) with an indications form 9 (e.g. displayed on the user interface 99 (see FIG. 3) of the client 6. It is recognised that the content of the indications form 9 (e.g. supplied by the request module 200 for use by user of the client 6) can be tailored to the particular physician placing the order, the patient 20 for which the order is being placed, and the exam 13 being requested. An example of the indications form 9 is shown in FIG. 7. The at least a portion of the content of the indications form 9 is used for the data 12 of the exam request 10. It is recognised that the operation 700 can be implemented as an exam request validation using a 1 stage (or more) process.

### First Stage

For example, at step 702 the matching module 202 uses the appropriateness content 112 of the definitions 102 to perform a first stage scoring (e.g. 0-4) of the exam data 12 through comparison with exam definitions 100 associated with the requested exam 13, as well as to exam definitions of other exam types 22 (optional). This first step 702 attempts to determine definitive appropriateness of the exam request 10 in view of the exam definitions 100 associated with one or more exam types 22 using the appropriateness content 112 (a.k.a Shallow Content) This content 112 is used to compare against the exam data 12 in order to determine definitive appropriateness (e.g. resulting in the validation indicator 15) with a subset of information derived from comparison to exam definitions 100 of the initially supplied exam data 12. The appropriateness content 112 is manipulated by the matching module 202 using a set of rules that can be similar to the decision support content 114, however these rules may not have the ability to return the questions 17 to the user. The appropriateness 112 rules implemented by the matching module 202 can be capable of: evaluating the requested exam 13 and the entire clinical condition represented by the exam data 12 of the advice session; 2) providing an appropriateness score (e.g. Advice Status as the indicator 15) for the advice session; 3) supporting logical expressions (e.g. AND, OR, NOT, EQUAL, GREATER THAN, LESS THAN); and/or 4) providing a suggested alternate examination type 22. Further, for example, the appropriateness 112 rules may not a provide tailored advice text for each rule and instead a predefined set of advice text can be presented as the validation indicator 15 for each Advice Status score as a resultant of the advice session.

For example, the validation score (e.g. validation indicator 15) is applied to procedure (e.g. exam data 12)/indication definition (e.g. exam definition 100) pairs, plus any additional clinical condition data. For the examination request 10, the highest scored indication (of the data 12) determines the initial level of appropriateness, e.g. if any one indication of the data 12 on a given requisition request 10 is scored Appropriate (e.g. indication value=4), the entire examination request 10 is deemed Appropriate and no further content may be applied. Further, the rules can be executed in a descending order, by their resulting appropriateness score, i.e. all 4's are evaluated first, followed by 3's, etc). This way, the first rule that matches the clinical condition is the proper score, and no further evaluation/processing of the exam request 10 may be needed. For example, if the matching module 202 returns a score of 4 (i.e. appropriate/valid), the user does not need to proceed to the second stage (i.e. Decision Support). Otherwise, the system 8 passes the clinical condition data 12 down to the Decision Support Content 114 of the second stage for processing by the interaction module 206. It is noted that if the Decision Support content 114 is not available/applicable for the requested exam 13, then the highest applicable score from the first stage (i.e. Appropriateness Content 112) is returned by the system in the validation response 15, including any suggested alternative procedures, and predefined advice text associated with the determined score.

Examples of the validation indicator 15 (e.g. Advice Status, also referred to as Clinical Score) are provided below. This value represents how appropriate the exam request 10 being validated is, namely (see FIGS. 8a,b,c,d for example indicators 15): [0—NotValidated: Based on the clinical condition (represented by the exam data 12), the requested exam 13 does not require validation; 1—Inappropriate: The requested exam 13 is not considered appropriate based on the clinical condition described, and the available evidence (represented by the exam data 12); 2—Indeterminate: Clinical appropriateness cannot be determined based on the currently encoded clinical condition (represented by the exam data 12). More questions may be asked of the user to determine appropriateness; 3—Moderate: The requested exam 13 is considered appropriate based on the clinical condition described, and the available evidence (represented by the exam data 12). However, an alternate examination type 22 may be: marginally more effective, less complex, or may expose the patient to a lower dose of radiation; and 4—Appropriate: The requested exam 13 is considered appropriate based on the clinical condition described, and the available evidence (represented by the exam data 12).

In any event, the validation indicator 15 gives the user of the client 6 confirmation as to whether the requested exam 13 is appropriate (e.g. valid), not appropriate (e.g. not valid), or considered somewhat appropriate where there may exist alternative examination types 22 in substitution for the requested exam 13. When the requested exam 13 is not deemed appropriate, the next step 704 can be implemented, namely Decision Support. Here the system 8 via the interaction module 206 gathers more granular structured data 12 from the user through questions 17 that is generally beyond the level of the indication form 9. Examples of the validation responses 14 are shown in FIGS. 8a,b,c,d. It is recognised that a user event 17 (e.g. a UI button or other UI control) can be used to launch the interactive module 206 as described below.

### Second Stage

Referring again to FIG. 6, at step 704 the interaction module 206 uses the appropriateness content 114 of the definitions 102 to obtain further exam information 19 (e.g. additional exam data 12 as a response to the questions 17) from the user of the client 6, in order to facilitate the generation of an appropriate indicator (i.e. validation indicator 15) for either the requested exam 13 or an alternative examination type 22, based on a comparison of the exam information 19 and the original exam data 12 (if applicable) with the exam definitions 100. Accordingly, if some content 114 applies, and the result is not Indeterminate, advice is presented in the advice session to the user. Lastly, if no definitive advice has been presented, Appropriateness Content 112 can be used to provide the best possible alternative procedure in substitution for the requested exam 13. See FIG. 8e for example questions 17.

Decision Support Content 114 (a.k.a Deep Content) is used by the interaction module 206 when the appropriateness content 112 cannot provide definitive appropriateness of the requested exam 13. The content 114 facilitates the collection of further information 19 from the user in response to questions 17 based on the content 114. This content 114 is capable of being used to ask the user questions 17 that will help gather the additional structured data as information 19 that can be used to supplement or otherwise replace the initially supplied exam data 12. The further information 13 is compared to the exam definitions 100 of the content 114 to change the initially provided validation indicator 15 (having a value other than appropriate), to provide suggested alternative exam types 22, and/or to provide customized advice text in the examination response 14 that can be used to educate the user on the proper use of the requested exam 13 (and/or the suggested alternative exam type(s) 22). Decision Support rules of the content 114 can be capable of: 1) evaluating the requested exam 13 and the entire clinical condition (e.g. represented by the exam data 12) stored in the Advice Session; 2) changing the appropriateness score (e.g. AdviceStatus) for the advice session; 3) supporting the following logical expressions of AND, OR, NOT, EQUAL, GREATER THAN, LESS THAN; 4) providing a suggested alternative exam type(s) 22; 5) firing, or not firing, based on the answer 19 to the question 17; and/or 6) providing customized Advice Text in the examination response 14.

Further, it is recognised that each time advice is requested from the content 114, all Decision Support rules covering the clinical condition in the advice session can be applied, even if they were applied in a previous call. This means Decision Support rules may not assume that another rule has already fired. However, rules may be skipped if an answer 19 for the associated questions 17 has already been stored in the advice session. As noted above, if the Decision Support content 114 does not have an applicable rule for the condition described by the exam data 12 in view of the requested exam 13 (or suggested alternative from the content 112), then the highest applicable score from the appropriateness content 112 is returned in the exam response 14, including any suggested alternative examination types 22 and canned advice text.

### Alternative Embodiment Operations of the Decision Support System 8

Referring to FIG. 9, shown is a further embodiment of interaction between the client 6, the system 8, and an optional third party server 7 configured for rendering the input data and output data screens compatible with the functionality of the exam request 10 and exam response 14 content as generated by the system 8. It is recognised that some or all of the functionality of the third party server 7 can be performed by the system 8, as desired.

FIG. 9 shows an operation 500 having following example steps: steps 502 and 504 where the client starts the exam request process (with optional involvement from the server 7 for rendering of appropriate screens for the exam request process; step 506 where the client 6 completes the exam data 12 (for example see FIG. 7); steps 508 and 510 where the client saves/submits the exam request 10 to the system 8 (and optionally to the server 7 as a middle server); step 512 where the system 8 invokes the matching module 202 and step 514 where determination of the validation indicator occurs (e.g. first stage); at step 516 where if determined as indeterminate, the corresponding validation indicator 15 is presented to the client 6 along with one or more questions 17; at steps 518 (and steps 508, 510) the client submits one or more answers 19 back to the system 8 in response; at step 512 the matching module 202 and/or the interaction module 206 processing the new answer information 19; at step 514 is now determined as not indeterminate, at step 520 the module 202,206 determines if the requested exam is appropriate; at step 522 if deemed inappropriate the corresponding validation indicator is presented to the client 6; at step 524 if the client follows the advice of the received response 14, the medical practitioner 18 loads the requisition form and then proceeds at step 526 to submit/initiate the requisition (i.e. initiates the scheduling of the patient for the exam 13,22 as validated in the response 14); otherwise at step 528 if the client 6 does not follow the advice provided in the response 14 at step 522, the client decides either to not proceed with the exam at step 530, or at step 534 saves the requisition as deciding to proceed along with the session ID 302 for further analysis at step 536. Otherwise, at step 532 if deemed appropriate (at step 520) the corresponding validation indicator 15 is presented to the client 6 for saving of the requisition at step 534 with the session ID 302 for further analysis at step 536.

Accordingly, in view of the operation 500 described above, Requisition Creation in this interaction we see an integration of the client 6 (and optionally the server 7) with Decision Support system 8. Here, only 1 interaction at step 512 is done at the time the requisition is created. The system 7 in this example, optionally, already maintains its own dictionaries of procedures (CPT4s) and indications (ICD9). The user of the client 6 interacts with the server 7 to create the requisition at step 526. The data 12 collected from the user is passed to the Request Advice API call (Interaction 1) at step 512. If determined Indeterminate or Moderate, further questions may be displayed to the user 6 at step 516 (Display 1). If determined Inappropriate, the system 8 displays the advice to the user 6 at step 522 (Display 2). Otherwise, the system 8 facilitates the user 6 to continue. It is noted that the system 8 and/or the server 7 can provides a default template (e.g. XSL—see display templates 209 of FIG. 2 for use by the response module 208) to render the validation data returned in Display 1 & 2, as desired.

Referring to FIG. 10, this diagram depicts a more detailed interaction 600 between the system 8 and the client 6. As noted above, the steps shown as implemented by the third party server 7 could be done as shown and/or implemented by the system 8 itself, as desired. For example, the third party server 7 may not maintain its own dictionaries of the definitions 102 and so relies on the system 8 for this information for configuring as a display on the client device 6. Also, in this embodiment the collection of exam data 12 happens when the exam requisition 10 is created by administrative staff (or initially by the medical practitioner), but the request for advice is not done until the medical practitioner 18 signs the requisition (through consultation with the details of the exam response 14). The user interacts with the server 7 to create the DI requisition (i.e. the initiated exam order).

The operation 600 has following example steps: steps 602 and 604 where the client starts the exam request process (with optional involvement from the server 7 for rendering of appropriate screens for the exam request process; steps 606, 608 where the system 8 provides a list of exam types 22 for selection of the specified exam 13; step 610 where the client selects the specified exam 13; steps 612, 614, 616 where the system 8 provides the definitions 102 corresponding to the specified exam 13 for facilitating entry of the exam data 12 in the exam request 10 at step 618; step 620 where the user 6 saves the exam request 10 (including the session IS 302) and submits same to the system 8; steps 622,624,626,628 where the exam request 10 is processed and a corresponding validation indicator is provided in the generated exam response 14, stored in the queue 210 (see FIG. 2); step 630 where a further asynchronous communication (including the session ID 302) is sent to the system 8 to start the sign/initiate process for the requisition at step 632; at step 634 the system 8 receives the request for access by the client 6 of the response 14; at step 636 the system 8 determines if the validation indicator 15 is indeterminate; if yes, at step 638 the system provides questions 17 to the client 6 and at step 640 the client submits answers 19 to the questions 17; steps 632, 634, 636 are repeated to determine if the validation indicator 15 is indeterminate; if no, at step 642 the system 8 determines if the validation indicator 15 is inappropriate; if yes, at step 644 the result 14 is submitted to the client 6 for display; at step 646 if the advice is followed, the requisition is submitted at step 648 and initiated by the medical practitioner 18.

Otherwise, if the advice is not followed at step 646, at step 650 the client determines whether to proceed with the current exam by saving the requisition including the session ID at steps 656, 658. Otherwise, the medical practitioner 18 does not proceed with the current exam at step 652. Further, if the validation indicator 15 at step 642 was deemed appropriate, then at step 654 it is determined either as appropriate or not validated or indeterminate with no suggested alternative and at steps 656 the requisition is saved including the session ID 302.

Accordingly, in view of the operation 600 described above, when the requisition form initially loads the definitions form 9 (see FIG. 7) is populated with a procedure list (Display 1) from the system 8, e.g. Get Basic Procedure List (Interaction 1). Once the user 6 selects a procedure, e.g. the specified exam 13, an indication list is presented (Display 2) based on the Get Indication Display List call (Interaction 2). The data 12 collected from the user 6 is passed to the Submit Clinical condition call (Interaction 3). At this point the requisition is saved and is waiting to be signed by the physician 18. Once the requisition is signed, a call to Request Advice (Interaction 1) returns any applicable advice or questions 17. If Indeterminate, further questions 17 are displayed to the user 6 (Display 3). If Inappropriate, display the advice to the user 6 (Display 4). Otherwise, allow the user 6 to continue. Implementation Models of Statement system 8

Referring to FIGS. 1 and 2, the system 8 can be implemented via a number of different implementation models. FIG. 1 can be used to show the system 8 implemented as a server side utility of one or more clients 6 (e.g. hospitals), such that the system 8 has remote interaction (for example over an extranet) with the medical practitioner 18. It is also recognised that the system 8 could be implemented as a client side utility on either the client device 6 itself and/or on the server 7 that is located on an intranet coupled to the client device 6.

Accordingly, the Decision Support system 8 can be provided as a series of W3C Web Service classes. These classes can provide third parties access to the decision support, procedures, and indications. Web Services can facilitate the reaching of a large greatest number of client devices 6 over the network 11 with a single programmatic interface. The WSDL for these services can also defines a series of state holder objects, and enumerations that provide structure for input and output data. For example, the web service API can be implemented using the Apache Axis 2 Java project and can be compatible with .Net and other web service consumers. Further, the Decision Support system 8 can be embodied as a rich API (e.g. an HTML based interface) that wraps the Web Service. This API can accept HTTP Post/Get parameters, from the clients 6, and return advice and questions formatted as HTML screens ready to present to a user (e.g. of the client device 6). This API wrapper can be used by implementers who prefer to launch the decision support system 8 capability rather than integrate with it directly into their application, for example.

What is claimed is:

1. A method for integrating decision support into user systems, the method comprising:
receiving examination information associated with an examination request in a user system, wherein the user system comprises at least one system from the group of electronic medical record (“EMR”) system, radiology information system (“RIS”) or a hospital information system (“HIS”);
generating a first applications program interface (“API”) call, from the user system to a decision support system, that comprises the examination information;
generating, at the decision support system, a return to the first API call a procedure list for display on the user system;
receiving input from the user, at the user system, to select a procedure from the procedure list;
generating a second API call, from the user system to the decision support system, to obtain a list of the indications for the selected procedure;
generating, at the decision support system, a return to the second API call that comprises an indication list that identifies indications appropriate for the selected procedure based on the examination data;
sending updated data associated with the exam request and a unique session from the user system to the decision support system, through a third API;
generating a fourth API call, from the user system to the decision support system, to obtain advise; and
generating, at the decision support system, a return to the fourth API call a procedure to return any applicable advice.

2. The method of claim 1, further comprising returning from the decision support system, in response to the fourth API call, a question for prompting an answer for use in updating the examination data associated with the unique session to result in updated content of the examination request.

3. The method of claim 1, wherein the examination request comprises a preliminary request that includes parameters selected from the group comprising: Procedure Coding Scheme; Procedure/Exam ID; Session ID; Patient Date of Birth; Patient Gender; and Physician Specialty, and in response a return communication to the second API call comprises the predefined clinical indications including suggested display logic as a list of indications with user interface display attributes for use in describing the clinical condition in detail.

4. The method of claim 1, wherein the examination request comprises a final request in the third API call for the submission of the exam data, the final request includes parameters selected from the group comprising: Session ID; Procedure/Exam Coding Scheme; Procedure/Exam ID; Patient Class; Patient Date of Birth; Patient Gender; Physician Specialty; Body Part; Selected Indications; Answers to Questions asked by Advice; and Procedure/Exam Description.

5. The method of claim 4, further comprising transmitting an answer to the question as an API return based on analysis of parameters associated with the unique session selected from the group comprising: Session ID; Procedure/Exam Coding Scheme; Procedure/Exam ID; Patient Class; Patient Date of Birth; Patient Gender; Physician Specialty; Body Part; Selected Indications; Answers to Questions asked by Advice; and Procedure/Exam Description, and the answer content is selected from the group comprising: Advice Text; Session Status; Requested Procedure/Exam; Recommended Procedure; Actions; Supporting Information about the advice; and further Questions.

6. The method of claim 1, further comprising storing an outcome of the unique session, wherein stored parameters of the outcome are selected from the group comprising: Session ID; Action Taken; Procedure/Exam Coding Scheme; Final Procedure/Exam ID; Physician ID; Physician Name; and Patient ID.
